(19) United States
(12) Patent Application Publication
(10) Pub. No.: US 2013/0061293 A1
(43) Pub. Date: Mar. 7, 2013

(54) METHOD AND APPARATUS FOR SECURING THE FULL LIFECYCLE OF A VIRTUAL MACHINE

(71) Applicant: Wenbo Mao, Beijing (CN)

(72) Inventor: Wenbo Mao, Beijing (CN)

(21) Appl. No.: 13/601,053

(22) Filed: Aug. 31, 2012

Related U.S. Application Data
(60) Provisional application No. 61/530,543, filed on Sep. 2, 2011.

(51) Int. Cl. G06F 21/00

(52) U.S. Cl. 726/4

(57) ABSTRACT

Systems and methods for securing a virtual machine are disclosed. Various embodiments of the systems and methods disclosed herein allow provisioning a trusted and secure computing environment to a user. Various embodiments enable securing a virtual machine during multiple states, such as during run time, construction time and rest time. In one embodiment, a virtualization infrastructure for securing a virtual machine includes a trusted computing base and a proxy virtual machine running on the virtualization infrastructure as a proxy of the trusted computing base, the trusted computing base being configured to cryptographically verify the proxy virtual machine to be authentic and to prevent unauthorized access to the proxy virtual machine. The proxy virtual machine may be configured to compute an exit state measurement of the virtual machine and to use the exit state measurement to prevent an unauthorized entry of the virtual machine into the virtualization infrastructure.

### CROSS REFERENCE TO RELATED APPLICATIONS

This application claims priority under 35 U.S.C. 119(e) to U.S. Provisional Patent Application No. 61/530,543, filed on Sep. 2, 2011, which is hereby incorporated by reference.

### BACKGROUND

1. Field of the Invention

The present invention is generally directed to virtualization technology and more specifically to systems and methods for securing a virtual machine.

2. Description of Background

Server virtualization technology is getting popular acceptance in cloud computing data centers. Server virtualization technology typically partitions a multi-user shared computing platform into a number of isolated information processing units, called guest virtual machines (GVMs or VMs). Each VM has its own CPU, memory, storage and network resources which are provided by the underlying hardware server via multiplexing, through the server virtualization technology.

Server virtualization technologies that are commercially available today include VMware ESX, Citrix Xen, Microsoft Hyper-V, Oracle VirtualBox and open source community's KVM. In these technologies, VM security protection is supported by a hypervisor, which is regarded as a software-based Trusted Computing Base (TCB). The Intel Trusted Execution Technology (TXT) combined with the Trusted Computing Group (TCG) technology have a hardware-based TCB to provide the software-based TCB with integrity protection, and an ability to report the protection to a user, thereby making the fact of protection verifiable by the user.

### SUMMARY OF INVENTION

According to aspects of the present invention, it is appreciated that a desirable quality of a VM security fitting for use by cloud data centers should be that any two VMs on the server are mutually disjoint and inaccessible to/from one another. Furthermore, any VM should not be accessible even by a data center system administrator, perhaps via using some resource management tools, without due authorization. It is also equally important that the data center should be able to provide the user with clear evidence for the latter to verify this quality of VM protection. VM security protection to exclude data center system administrators outside the trust boundary, and an ability to manifest this quality of VM security protection to the user, form a crucial quality of service to make a cloud data center more trustworthy and secure than others for attracting more users.

Virtualization systems and technologies, such as those noted in the background section, may provide security protection to code and data of a VM at the VM run time when the code and data are in the Random Access Memory (RAM). However, in modern computer architecture design, the RAM is architected to have a relatively small size and thereby small processing latency for holding and fast processing the machine's small quantity of fast changing code and data. A computer must also have much-larger-than-RAM-size external storage spaces, e.g., hard disks, USB or CD drives which may be the machine's local peripherals or may even be remote ones over a public network, for storing, for example, the machine's large quantity of not-so-frequently-changing code and/or data. While the virtualization systems may securely protect the VM's RAM space against unauthorized access, they cannot do so for the VM's external storage spaces. Also, run time is only one of the three stages in the full lifecycle of the VM; the other two stages in the full lifecycle of the VM are construction time and rest time of the VM. The VM construction time may refer to when a VM is constructed and/or initialized to include the complete code and data for a guest operating system and applications, and these code and data may be packed in the form of a VM image file stored in an external storage in local or remote peripherals. The VM rest time may refer to a period of time between when a VM is temporarily stopped and when the temporarily stopped VM is re-launched; during this period, the VM image file may be stored in an external storage in local or remote peripherals. The VM rest time may also be referred to as hibernate time.

According to aspects of the present invention, it is appreciated that existing virtualization systems and technologies do not provide sufficient security protection to the VM's code and data in the external storage spaces at either run time, construction time or rest time. For instance, Amazon Web Service (AWS) Elastic Cloud Compute (EC2) provides a tenant user with web service Application Programming Interface (API) managed tool for constructing an EC2 (a guest VM). However, the user is required to completely trust this VM construction tool. The demand on the user to unconditionally trust the cloud data center constitutes a very strong security assumption because lack of trust in the public cloud is the very problem in the first place. Furthermore, in AWS, when a tenant stops (or hibernates) an EC2, the VM image file is stored in an external storage of the AWS, for example the Simple Storage Service (S3). However, AWS never provides any means of protection for the stopped VM image file, for example, no means of integrity protection for the stopped VM image file, regardless of the fact that integrity protection of a VM image file is indispensible, as will be described in further detail below. Integrity protection will generally need an execution environment which is verifiably trusted by the tenant to compute crypto mechanisms; however there is not such an environment in AWS to perform this function.

As an example, consider a simple attack which may be launched by a rogue system administrator in a cloud data center, such as AWS. A rogue cloud system administrator may launch this attack to obtain a tenant's root password. First, the administrator may duplicate a guest VM that is initialized for a tenant. Then the administrator may reset the root password of the duplicated VM to gain control of the VM. The administrator may then obtain the Secure Shell (SSH) cryptographic credential in the duplicated VM, which is identical to the one in the tenant's VM. With the tenant's SSH credential, the rogue administrator may intercept the network traffic between the tenant and the VM, and may decrypt the SSH sessions and get all users' data in the traffic, including the passwords of these users, and in particular the root password that the tenant setup when the VM was used for the first time.

A fundamental problem behind the above attack is that the current virtualization infrastructure and technologies used in commercially operating cloud data centers lack an environment which can be verifiably trusted by a tenant (user) to provide protection to the full lifecycle of a VM of the tenant. Accordingly, one aspect of the present disclosure is directed to providing a proper integrity protection to the tenant's VM upon the VM re-launch. With the proper integrity protection, the duplicated VM with reset password will give rise to an error in integrity upon its re-launch by the rogue system administrator. According to one aspect of the present disclosure, a VM integrity protection during run time may include measuring a VM image file and securely saving the measurement upon the VM outputting data to the VM image file, and then re-measuring and verifying upon the VM inputting data from the VM image file. According to another aspect of the present disclosure, a VM integrity protection during rest time may include measuring a VM image file and securely saving the measurement upon the VM hibernation or stoppage, and then re-measuring and verifying upon the VM re-launch. The acts of measuring, securely saving, re-measuring and verifying may necessarily involve cryptographic processes. However, so far there exists no cloud computing technology in today's cloud data centers to provide a trusted environment to process trusted crypto algorithms for tenants. Various aspects of the present disclosure are directed to addressing the above problems. According to one aspect, methods and systems for securing the code and/or data of a virtual machine when the code and/or data are in an external storage space, being output from or being input to the virtual machine are provided. According to one aspect, the code and/or data of a virtual machine are secured using cryptographic methods. According to one aspect, the code and/or data of the virtual machine are secured during at least one of construction time, run time and rest time of the virtual machine.

According to one aspect, there is provided a virtualization infrastructure for securing a virtual machine, the virtualization infrastructure including a trusted computing base configured to prevent unauthorized access to the virtual machine running on the virtualization infrastructure; a proxy virtual machine running on the virtualization infrastructure as a proxy of the trusted computing base, the trusted computing base further being configured to use a cryptographic method to verify the proxy virtual machine to have authentication and confidentiality properties to prevent unauthorized access to the proxy virtual machine; the proxy virtual machine having authentication and confidentiality properties and being configured to compute an exit state measurement of the virtual machine at a time when the virtual machine exits the virtualization infrastructure and to use the exit state measurement to prevent an unauthorized entry of the virtual machine into the virtualization infrastructure.

In some embodiments of the virtualization infrastructure, the virtual machine includes one or more blocks of data and the proxy virtual machine is configured to compute the exit state measurement using at least one block of the one or more blocks. In some embodiments, the virtual machine includes one or more blocks of data and the proxy virtual machine is configured to compute the exit state measurement for each block of the one or more blocks. In some embodiments of the virtualization infrastructure, the proxy virtual machine is configured to compute the exit state measurement using an image file of the virtual machine. In some embodiments, the proxy virtual machine is further configured to cryptographically secure the exit state measurement.

In some embodiments, the proxy virtual machine is configured to compute a resuming state measurement of the virtual machine at a time when a request to enter the virtual machine into the virtualization infrastructure is received; to compare the resuming state measurement with the exit state measurement; to prevent an unauthorized entry of the virtual machine into the virtualization infrastructure based on a negative outcome of the comparison; and to allow the virtual machine to run on the virtualization infrastructure based on a positive outcome of the comparison. In some embodiments, the virtual machine includes one or more blocks of data and the proxy virtual machine is configured to compute the resuming state measurement for each block of the one or more blocks and to compare the resuming state measurement with the exit state measurement for each block of the one or more blocks.

In some embodiments of the virtualization infrastructure, the proxy virtual machine is further configured to securely construct the virtual machine, to compute an initial state measurement of the virtual machine at a time when the virtual machine is constructed, and to use the initial state measurement to prevent an unauthorized initial running of the virtual machine on the virtualization infrastructure. In some embodiments, the virtual machine includes one or more blocks of data and the proxy virtual machine is configured to compute the initial state measurement for each block of the one or more blocks.

In some embodiments, the virtualization infrastructure is configured to run on a cloud computing data center. In some embodiments, the trusted computing base is further configured to prevent unauthorized access to the virtual machine by an administrator of the cloud computing data center; and the proxy virtual machine is further configured to prevent unauthorized entry of the virtual machine into the virtualization infrastructure by the administrator of the cloud computing data center.

In some embodiments, the trusted computing base is configured to run in a first layer of the virtualization infrastructure, the virtual machine is configured to run in a second layer of the virtualization infrastructure, the first layer being more privileged than the second layer. In some embodiments, the proxy virtual machine is configured to run in the second layer of virtualization infrastructure.

In some embodiments, the trusted computing base includes a hypervisor or a micro kernel. In some embodiments, the trusted computing base includes a memory protection module configured to partition a memory of the virtualization infrastructure into a plurality of memory sections, the plurality of memory sections being mutually disjoint; maintain a 1:1 access relationship between a memory section of the plurality of memory sections and the virtual machine; and maintain a trusted computing base memory section accessible only by the trusted computing base. In some embodiments, the virtualization infrastructure further includes a housekeeping virtual machine running on the virtualization infrastructure, the memory protection module being further configured to allow the housekeeping virtual machine to maintain the 1:1 access relationship between a memory section of the plurality of memory sections and the virtual machine. In some embodiments, the trusted computing base further includes an input-output policy control module configured to control access between a peripheral device and a memory section. In some embodiments, the virtual machine has a processor context and the trusted computing base further includes a processor context protection module configured to maintain a 1:1 access relationship between the processor context and the virtual machine.

In some embodiments, the virtualization infrastructure is configured to operate in a first computing environment and the proxy virtual machine is constructed in a second computing environment, the second computing environment being separate and independent from the first computing environment. In some embodiments, the trusted computing base is further configured to cryptographically recognize and trust the second computing environment and to receive the proxy virtual machine from the second computing environment. In some embodiments of the virtualization infrastructure, the proxy virtual machine is cryptographically encoded on the second computing environment using a cryptographic method, and the trusted computing base is further configured to receive the cryptographically encoded proxy virtual machine from the second computing environment and to cryptographically decode the proxy virtual machine using the cryptographic method.

According to another aspect, there is provided a virtualization infrastructure for securing a virtual machine, the virtualization infrastructure including a trusted computing base configured to prevent unauthorized access to the virtual machine running on the virtualization infrastructure; a proxy virtual machine running on the virtualization infrastructure as a proxy of the trusted computing base, the trusted computing base further being configured to cryptographically verify the proxy virtual machine to have authentication and confidentiality properties to prevent unauthorized access to the proxy virtual machine; the proxy virtual machine having authentication and confidentiality properties and being configured to securely construct the virtual machine, to compute an initial state measurement of the virtual machine at a time when the virtual machine is constructed, and to use the initial state measurement to prevent an unauthorized initial running of the virtual machine on the virtualization infrastructure.

In some embodiments of the virtualization infrastructure, the virtual machine includes one or more blocks of data and the proxy virtual machine is configured to compute the initial state measurement for each block of the one or more blocks. In some embodiments, the proxy virtual machine is further configured to generate an image file for the virtual machine. In some embodiments, the proxy virtual machine is further configured to securely store the image file on a storage space external to the virtualization infrastructure.

In some embodiments, the proxy virtual machine is configured to receive from a user a request to construct the virtual machine. In some embodiments, the proxy virtual machine is configured to run upon receipt of the request to construct the virtual machine an authentication protocol to verify an identity of the user; and an attestation protocol to report an identity of the virtualization infrastructure to the user; and to establish a secure two-way communication channel with the user in response to a successful authentication and attestation. In some embodiments, the proxy virtual machine is configured to report a configuration of the virtualization infrastructure to the user. In some embodiments, the proxy virtual machine is configured to receive data from the user via the secure two-way communication channel, and to use the data to construct and initialize the virtual machine.

In some embodiments, the proxy virtual machine is configured to cryptographically secure the initial state measurement. In some embodiments, the proxy virtual machine is configured to compute a resuming state measurement of the virtual machine at a time when a request to initially run the virtual machine on the virtualization infrastructure is received; to compare the resuming state measurement with the initial state measurement; to prevent an unauthorized initial running of the virtual machine on the virtualization infrastructure based on a negative outcome of the comparison; and to allow the virtual machine to run on the virtualization infrastructure based on a positive outcome of the comparison. In some embodiments, the virtual machine includes one or more blocks of data and the proxy virtual machine is configured to compute the resuming state measurement for each block of the one or more blocks and to compare the resuming state measurement with the initial state measurement for each block of the one or more blocks.

In some embodiments, the virtualization infrastructure is configured to run on a cloud computing data center. In some embodiments, the trusted computing base is further configured to prevent unauthorized access to the virtual machine by an administrator of the cloud computing data center; and the proxy virtual machine is further configured to prevent unauthorized initial running of the virtual machine on the virtualization infrastructure by the administrator of the cloud computing data center.

In some embodiments, the trusted computing base is configured to run in a first layer of the virtualization infrastructure, the virtual machine is configured to run in a second layer of the virtualization infrastructure, the first layer being more privileged than the second layer. In some embodiments, the proxy virtual machine is configured to run in the second layer of the virtualization infrastructure.

In some embodiments, the trusted computing base includes a hypervisor or a micro kernel. In some embodiments, the trusted computing base includes a memory protection module configured to partition a memory of the virtualization infrastructure into a plurality of memory sections, the plurality of memory sections being mutually disjoint; maintain a 1:1 access relationship between a memory section of the plurality of memory sections and the virtual machine; and maintain a trusted computing base memory section accessible only by the trusted computing base. In some embodiments, the virtualization infrastructure further includes a housekeeping virtual machine running on the virtualization infrastructure, the memory protection module being further configured to allow the housekeeping virtual machine to maintain the 1:1 access relationship between a memory section of the plurality of memory sections and the virtual machine. In some embodiments, the trusted computing base further includes an input-output policy control module configured to control access between a peripheral device and a memory section. In some embodiments, the virtual machine has a processor context and the trusted computing base further includes a processor context protection module configured to maintain a 1:1 access relationship between the processor context and the virtual machine.

In some embodiments, the virtualization infrastructure is configured to operate in a first computing environment and the proxy virtual machine is constructed in a second computing environment, the second computing environment being separate and independent from the first computing environment. In some embodiments, the trusted computing base is further configured to cryptographically recognize and trust the second computing environment and to receive the proxy virtual machine from the second computing environment. In some embodiments of the virtualization infrastructure, the proxy virtual machine is cryptographically encoded on the second computing environment using a cryptographic method, and the trusted computing base is further configured to receive the cryptographically encoded proxy virtual machine from the second computing environment and to cryptographically decode the proxy virtual machine using the cryptographic method.

According to another aspect, there is provided a virtualization infrastructure for securing a virtual machine, the virtualization infrastructure including a trusted computing base configured to prevent unauthorized access to the virtual machine running on the virtualization infrastructure; a proxy virtual machine running on the virtualization infrastructure as a proxy of the trusted computing base, the trusted computing base further being configured to use a cryptographic method to verify the proxy virtual machine to have authentication and confidentiality properties to prevent unauthorized access to the proxy virtual machine; the proxy virtual machine having authentication and confidentiality properties and being configured to compute an exit state measurement of an image file of the virtual machine at a time when the virtual machine outputs data to the image file of the virtual machine and to use the exit state measurement to prevent an unauthorized running of the virtual machine on the virtualization infrastructure.

In some embodiments, the image file of the virtual machine includes one or more blocks of data and the proxy virtual machine is configured to compute the exit state measurement using at least one block of the one or more blocks. In some embodiments, the image file of the virtual machine includes one or more blocks of data and the proxy virtual machine is configured to compute the exit state measurement for each block of the one or more blocks. In some embodiments, the proxy virtual machine is configured to cryptographically secure the exit state measurement.

In some embodiments, the proxy virtual machine is configured to compute a resuming state measurement of the image file of the virtual machine at a time when the virtual machine inputs data from the image file of the virtual machine; to compare the resuming state measurement with the exit state measurement; to prevent an unauthorized running of the virtual machine on the virtualization infrastructure based on a negative outcome of the comparison; and to allow the virtual machine to run on the virtualization infrastructure based on a positive outcome of the comparison. In some embodiments, the image file of the virtual machine includes one or more blocks of data and the proxy virtual machine is configured to compute the resuming state measurement for each block of the one or more blocks and to compare the resuming state measurement with the exit state measurement for each block of the one or more blocks.

In some embodiments, the proxy virtual machine is further configured to securely construct the virtual machine, to compute an initial state measurement of the image file of the virtual machine at a time when the virtual machine is constructed, and to use the initial state measurement to prevent an unauthorized initial running of the virtual machine on the virtualization infrastructure. In some embodiments, the image file of the virtual machine includes one or more blocks of data and the proxy virtual machine is configured to compute the initial state measurement for each block of the one or more blocks. In some embodiments, the proxy virtual machine is further configured to receive from a user a request to construct the virtual machine. In some embodiments, the proxy virtual machine is further configured to run upon receipt of the request to construct the virtual machine an authentication protocol to verify an identity of the user; and an attestation protocol to report an identity of the virtualization infrastructure to the user; and to establish a secure two-way communication channel with the user in response to a successful authentication and attestation. In some embodiments, the proxy virtual machine is further configured to report a configuration of the virtualization infrastructure to the user. In some embodiments, the proxy virtual machine is further configured to receive data from the user via the secure two-way communication channel, and to use the data to construct and initialize the virtual machine. In some embodiments, the proxy virtual machine is further configured to cryptographically secure the initial state measurement.

In some embodiments, the virtualization infrastructure is configured to run on a cloud computing data center. In some embodiments, the trusted computing base is further configured to prevent unauthorized access to the virtual machine by an administrator of the cloud computing data center; and the proxy virtual machine is further configured to prevent unauthorized running of the virtual machine on the virtualization infrastructure by the administrator of the cloud computing data center.

In some embodiments, the virtualization infrastructure is configured to operate in a first computing environment and the proxy virtual machine is constructed in a second computing environment, the second computing environment being separate and independent from the first computing environment. In some embodiments, the trusted computing base is configured to cryptographically recognize and trust the second computing environment and to receive an image file of the proxy virtual machine from the second computing environment. In some embodiments, the image file of the proxy virtual machine is cryptographically encoded on the second computing environment using a cryptographic method, and the trusted computing base is configured to receive the cryptographically encoded image file of the proxy virtual machine from the second computing environment and to cryptographically decode the image file of the proxy virtual machine using the cryptographic method.

According to another aspect, there is provided a secure computing system comprising a virtual machine having exclusive use of a memory section, a processor context, a storage space and an input-output peripheral, the virtual machine being accessible by an authorized user; a trusted computing base configured to prevent unauthorized access to the virtual machine while the virtual machine is running; a proxy virtual machine running as a proxy of the trusted computing base; the trusted computing base further being configured to cryptographically verify the proxy virtual machine to have authentication and confidentiality properties to prevent unauthorized access to the proxy virtual machine; the proxy virtual machine having authentication and confidentiality properties and being configured to compute an exit state measurement of the virtual machine at a time when the virtual machine stops running and to use the exit state measurement to prevent an unauthorized resuming of the virtual machine; and the proxy virtual machine being further configured to securely construct the virtual machine in response to a request from the authorized user, to compute an initial state measurement of the virtual machine at a time when the virtual machine is constructed, and to use the initial state measurement to prevent an unauthorized initial running of the virtual machine.

In various embodiments, the secure computing system may further be configured according to one or more features disclosed with reference to the various embodiments of the virtualization infrastructure.

According to another aspect, there is provided a virtualization infrastructure for securing a virtual machine, the virtualization infrastructure including a trusted computing base configured to prevent unauthorized access to the virtual machine running on the virtualization infrastructure, the virtualization infrastructure being configured to compute an exit state measurement of an image file of the virtual machine at a time when the virtual machine outputs data to the image file of the virtual machine and to use the exit state measurement to prevent an unauthorized running of the virtual machine on the virtualization infrastructure. In some embodiments, the virtualization infrastructure may not include a proxy virtual machine and the virtualization infrastructure may further be configured to perform one or more acts disclosed herein in lieu of the proxy virtual machine.

According to another aspect, there is provided a method for securing a virtual machine of a user, the method comprising running a trusted computing base on a virtualization infrastructure; cryptographically verifying the authenticity and confidentiality of a proxy virtual machine by using the trusted computing base; running the proxy virtual machine on the virtualization infrastructure as a proxy of the trusted computing base, after verifying that the proxy virtual machine has authentication and confidentiality properties; preventing unauthorized access to the proxy virtual machine by using the trusted computing base; preventing unauthorized access to the virtual machine by using the trusted computing base, while the virtual machine is running on the virtualization infrastructure; computing an exit state measurement of the virtual machine by using the proxy virtual machine, at a time when the virtual machine exits the virtualization infrastructure; and preventing an unauthorized entry of the virtual machine into the virtualization infrastructure based on the exit state measurement, by using the proxy virtual machine.

In some embodiments, the virtual machine includes one or more blocks of data and computing an exit state measurement of the virtual machine includes computing a respective exit state measurement for each block of the one or more blocks, the exit state measurement including the respective exit state measurement for each block of the one or more blocks. In some embodiments, computing an exit state measurement includes using an image file of the virtual machine to compute the exit state measurement. In some embodiments, the method of securing the virtual machine further includes cryptographically securing the exit state measurement. In some embodiments, the method includes securely storing an image file of the virtual machine in an external storage after the virtual machine exits the virtualization infrastructure.

In some embodiments, preventing unauthorized entry of the virtual machine into the virtualization infrastructure includes decrypting the virtual machine at a time when a request is received to enter the virtual machine into the virtualization infrastructure; computing a resuming state measurement of the decrypted virtual machine; comparing the resuming state measurement with the exit state measurement; preventing an unauthorized entry of the virtual machine into the virtualization infrastructure based on a negative outcome of the comparing act; and allowing the virtual machine to run on the virtualization infrastructure based on a positive outcome of the comparing act. In some embodiments, the virtual machine includes one or more blocks of data and computing a resuming state measurement of the decrypted virtual machine includes computing a respective resuming state measurement for each block of the one or more blocks, the resuming state measurement including the respective resuming state measurement for each block of the one or more blocks.

In some embodiments, the method further includes securely constructing the virtual machine by using the proxy virtual machine, upon receiving a request from the user to construct the virtual machine; computing an initial state measurement of the virtual machine by using the proxy virtual machine, at a time when the virtual machine is constructed; and preventing an unauthorized initial running of the virtual machine on the virtualization infrastructure based on the initial state measurement, by using the proxy virtual machine. In some embodiments, the virtual machine includes one or more blocks of data and computing an initial state measurement of the virtual machine includes computing a respective initial state measurement for each block of the one or more blocks, the initial state measurement including the respective initial state measurement for each block of the one or more blocks.

In some embodiments, the method includes running the virtualization infrastructure in a cloud computing data center. In some embodiments, the acts of preventing unauthorized access to the virtual machine and preventing unauthorized access to the proxy virtual machine further include preventing unauthorized access by an administrator of the cloud computing data center; and preventing unauthorized entry further includes preventing unauthorized entry by the administrator of the cloud computing data center.

In some embodiments, the method further includes providing to the user evidence of preventing unauthorized access to the virtual machine; and providing to the user evidence of preventing an unauthorized entry.

In some embodiments, running a trusted computing base further includes running the trusted computing base on a first layer of the virtualization infrastructure, the method further including configuring the virtual machine to run in a second layer of the virtualization infrastructure, wherein the first layer is more privileged than the second layer. In some embodiments, running the proxy virtual machine further includes running the proxy virtual machine on the second layer of the virtualization infrastructure. In some embodiments, the trusted computing base includes a hypervisor or a micro kernel. In some embodiments, the method includes protecting a memory of the virtualization infrastructure by using the trusted computing base; protecting a processor context of the virtual machine by using the trusted computing base; and controlling access between a peripheral device and the memory of the virtualization infrastructure by using the trusted computing base. In some embodiments, protecting a memory of the virtualization infrastructure further includes partitioning the memory into a plurality of mutually disjoint memory sections; maintaining a 1:1 access relationship between a memory section of the plurality of memory sections and the virtual machine; and maintaining a trusted computing base memory section accessible only by the trusted computing base. In some embodiments, the method further includes running a housekeeping virtual machine on the virtualization infrastructure and maintaining a 1:1 access relationship further includes using the housekeeping virtual machine to maintain the 1:1 access relationship. In some embodiments, protecting a processor context of the virtual machine further includes maintaining a 1:1 access relationship between the processor context and the virtual machine. In some embodiments, preventing unauthorized access to the proxy virtual machine further includes protecting a memory section and a processor context of the proxy virtual machine by using the trusted computing base.

In some embodiments, the method further includes constructing the proxy virtual machine in a separate computing environment that is independent from the virtualization infrastructure; cryptographically recognizing and trusting the separate computing environment by the trusted computing base; and transferring the proxy virtual machine from the separate computing environment to the trusted computing base. In some embodiments, the method further includes cryptographically encoding the proxy virtual machine on the separate computing environment using a cryptographic method to generate a cryptographically encoded proxy virtual machine; receiving the cryptographically encoded proxy virtual machine by the trusted computing base; and cryptographically decoding the cryptographically encoded proxy virtual machine using the cryptographic method on the trusted computing base.

According to another aspect, there is provided a method for securing a virtual machine of a user, the method comprising running a trusted computing base on a virtualization infrastructure; cryptographically verifying the authenticity and confidentiality of a proxy virtual machine by using the trusted computing base; running the proxy virtual machine on the virtualization infrastructure as a proxy of the trusted computing base, after verifying that the proxy virtual machine is authentic; preventing unauthorized access to the proxy virtual machine by using the trusted computing base; securely constructing the virtual machine by using the proxy virtual machine, upon receiving a request from the user to construct the virtual machine; computing an initial state measurement of the virtual machine by using the proxy virtual machine, at a time when the virtual machine is constructed; preventing an unauthorized initial running of the virtual machine on the virtualization infrastructure based on the initial state measurement, by using the proxy virtual machine; and preventing unauthorized access to the virtual machine by using the trusted computing base, while the virtual machine is running on the virtualization infrastructure.

In some embodiments, the virtual machine includes one or more blocks of data and computing an initial state measurement of the virtual machine includes computing a respective initial state measurement for each block of the one or more blocks, the initial state measurement including the respective initial state measurement for each block of the one or more blocks. In some embodiments, securely constructing further includes generating an image file for the virtual machine. In some embodiments, computing an initial state measurement includes using the image file to compute the initial state measurement. In some embodiments, the method includes securely storing the image file on a storage space external to the virtualization infrastructure.

In some embodiments, securely constructing further includes authenticating an identity of the user; running a platform attestation protocol to report an identity of the virtualization infrastructure to the user; and establishing a secure two-way communication channel with the user in response to a successful authentication and attestation. In some embodiments, running a platform attestation protocol further includes reporting a configuration of the virtualization infrastructure to the user. In some embodiments, securely constructing further includes receiving data from the user via the secure communication channel; and using the data to construct and initialize the virtual machine. In some embodiments, the method further includes cryptographically securing the initial state measurement.

In some embodiments, the method further includes running the virtualization infrastructure in a cloud computing data center. In some embodiments, the acts of preventing unauthorized access to the proxy virtual machine, securely constructing, and preventing unauthorized access to the virtual machine further include preventing unauthorized access by an administrator of the cloud computing data center; and preventing unauthorized initial running further includes preventing unauthorized initial running by the administrator of the cloud computing data center.

In some embodiments, the method further includes providing to the user evidence of securely constructing the virtual machine; and providing to the user evidence of preventing unauthorized access to the virtual machine.

In some embodiments, running a trusted computing base further includes running the trusted computing base on a first layer of the virtualization infrastructure, the method further including configuring the virtual machine to run in a second layer of the virtualization infrastructure, wherein the first layer is more privileged than the second layer. In some embodiments, running the proxy virtual machine further includes running the proxy virtual machine on the second layer of the virtualization infrastructure.

In some embodiments, the trusted computing base includes a hypervisor or a micro kernel. In some embodiments, the method includes protecting a memory of the virtualization infrastructure by using the trusted computing base; protecting a processor context of the virtual machine by using the trusted computing base; and controlling access between a peripheral device and the memory of the virtualization infrastructure by using the trusted computing base. In some embodiments, protecting a memory of the virtualization infrastructure further includes partitioning the memory into a plurality of mutually disjoint memory sections; maintaining a 1:1 access relationship between a memory section of the plurality of memory sections and the virtual machine; and maintaining a trusted computing base memory section accessible only by the trusted computing base. In some embodiments, the method further includes running a housekeeping virtual machine on the virtualization infrastructure and maintaining a 1:1 access relationship further includes using the housekeeping virtual machine to maintain the 1:1 access relationship. In some embodiments, protecting a processor context of the virtual machine further includes maintaining a 1:1 access relationship between the processor context and the virtual machine. In some embodiments, preventing unauthorized access to the proxy virtual machine further includes protecting a memory section and a processor context of the proxy virtual machine by using the trusted computing base.

In some embodiments, the method further includes constructing the proxy virtual machine in a separate computing environment that is independent from the virtualization infrastructure; cryptographically recognizing and trusting the separate computing environment by the trusted computing base; and transferring the proxy virtual machine from the separate computing environment to the trusted computing base. In some embodiments, the method further includes cryptographically encoding the proxy virtual machine on the separate computing environment using a cryptographic method to generate a cryptographically encoded proxy virtual machine; receiving the cryptographically encoded proxy virtual machine by the trusted computing base; and cryptographically decoding the cryptographically encoded proxy virtual machine using the cryptographic method on the trusted computing base.

According to another aspect, there is provided a method for securing a virtual machine of a user, the method comprising running a trusted computing base on a virtualization infrastructure; cryptographically verifying the authenticity and confidentiality of a proxy virtual machine by using the trusted computing base; running the proxy virtual machine on the virtualization infrastructure as a proxy of the trusted computing base, after verifying that the proxy virtual machine has authentication and confidentiality properties; preventing unauthorized access to the proxy virtual machine by using the trusted computing base; preventing unauthorized access to the virtual machine by using the trusted computing base, while the virtual machine is running on the virtualization infrastructure; computing an exit state measurement of the virtual machine by using the proxy virtual machine, at a time when the virtual machine outputs data to an image file of the virtual machine; and preventing an unauthorized running of the virtual machine on the virtualization infrastructure based on the exit state measurement, by using the proxy virtual machine.

In some embodiments, the image file of the virtual machine includes one or more blocks of data and computing an exit state measurement of the virtual machine includes computing a respective exit state measurement for each block of the one or more blocks, the exit state measurement including the respective exit state measurement for each block of the one or more blocks. In some embodiments, the method further includes cryptographically securing the exit state measurement.

In some embodiments, preventing unauthorized running of the virtual machine on the virtualization infrastructure further includes decrypting at least one block of data of the image file of the virtual machine at a time when the virtual machine inputs data from the image file of the virtual machine; computing a resuming state measurement of the at least one decrypted block of data of the virtual machine; comparing the resuming state measurement with the exit state measurement; preventing an unauthorized running of the virtual machine on the virtualization infrastructure based on a negative outcome of the comparing act; and allowing the virtual machine to run on the virtualization infrastructure based on a positive outcome of the comparing act.

In some embodiments, the method further includes running the virtualization infrastructure in a cloud computing data center. In some embodiments, the acts of preventing unauthorized access to the virtual machine and preventing unauthorized access to the proxy virtual machine further include preventing unauthorized access by an administrator of the cloud computing data center and preventing unauthorized running further includes preventing unauthorized running by the administrator of the cloud computing data center.

In some embodiments, preventing unauthorized access to the proxy virtual machine further includes protecting a memory section and a processor context of the proxy virtual machine by using the trusted computing base. In some embodiments, the method further includes providing to the user evidence of preventing unauthorized access to the virtual machine and providing to the user evidence of preventing an unauthorized running.

In some embodiments, the method further includes securely constructing the virtual machine by using the proxy virtual machine, upon receiving a request from the user to construct the virtual machine; computing an initial state measurement of the virtual machine by using the proxy virtual machine, at a time when the virtual machine is constructed; and preventing an unauthorized initial running of the virtual machine on the virtualization infrastructure based on the initial state measurement, by using the proxy virtual machine. In some embodiments, the virtual machine includes one or more blocks of data and computing an initial state measurement of the virtual machine includes computing a respective initial state measurement for each block of the one or more blocks, the initial state measurement including the respective initial state measurement for each block of the one or more blocks. In some embodiments, securely constructing the virtual machine further includes generating an image file for the virtual machine. In some embodiments, securely constructing further includes authenticating an identity of the user; running a platform attestation protocol to report an identity of the virtualization infrastructure to the user; and establishing a secure two-way communication channel with the user in response to a successful authentication and attestation. In some embodiments, running a platform attestation protocol further includes reporting a configuration of the virtualization infrastructure to the user. In some embodiments, securely constructing further includes receiving data from the user via the secure communication channel and using the data to construct and initialize the virtual machine. In some embodiments, the method includes cryptographically securing the initial state measurement. In some embodiments, the method includes providing to the user evidence of securely constructing the virtual machine and providing to the user evidence of preventing unauthorized access to the virtual machine.

In some embodiments, the method further includes constructing the proxy virtual machine in a separate computing environment that is independent from the virtualization infrastructure; cryptographically recognizing and trusting the separate computing environment by the trusted computing base; and transferring the proxy virtual machine from the separate computing environment to the trusted computing base. In some embodiments, the method includes cryptographically encoding the proxy virtual machine on the separate computing environment using a cryptographic method to generate a cryptographically encoded proxy virtual machine; receiving the cryptographically encoded proxy virtual machine by the trusted computing base; and cryptographically decoding the cryptographically encoded proxy virtual machine using the cryptographic method on the trusted computing base.

According to another aspect, there is provided a method for securing a virtual machine of a user, the method comprising running a trusted computing base on a virtualization infrastructure; preventing unauthorized access to the virtual machine by using the trusted computing base, while the virtual machine is running on the virtualization infrastructure; computing an exit state measurement of the virtual machine by using the virtualization infrastructure, at a time when the virtual machine outputs data to an image file of the virtual machine; and preventing an unauthorized running of the virtual machine on the virtualization infrastructure based on the exit state measurement. In some embodiments, one of more acts of securing a virtual machine as disclosed herein may be performed by the virtualization infrastructure in lieu of a proxy virtual machine.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a block diagram of an exemplary computer system upon which various aspects of the present embodiments may be implemented;

FIG. 2 is a block diagram illustrating one embodiment of a virtualization infrastructure according to aspects of the present invention;

FIG. 3 is a block diagram illustrating one embodiment of a proxy virtual machine according to aspects of the present invention;

FIG. 4 is a block diagram illustrating an exemplary method of securing a virtual machine at construction time using a proxy virtual machine according to aspects of the present invention;

FIG. 5 is a block diagram illustrating an exemplary method of securing the virtual machine of FIG. 4 following construction time and during initial running according to aspects of the present invention;

FIG. 6 is a block diagram illustrating an exemplary method of securing the virtual machine of FIG. 5 during run time and during rest time between when the virtual machine exits the virtualization infrastructure and when the virtual machine enters the virtualization infrastructure according to aspects of the present invention; and

FIG. 7 is a block diagram illustrating an exemplary method of securing a proxy virtual machine according to aspects of the present invention.

### DETAILED DESCRIPTION

Aspects and embodiments disclosed herein are directed to providing systems and methods for provisioning a trusted and secure computing environment to a user. Various embodiments of the present invention address the challenges described above and enable securing the full lifecycle of a virtual machine.

According to one aspect, a virtualization infrastructure (VI) for securing a virtual machine may be provided. In one embodiment, the VI includes a trusted computing base (TCB) which executes in the highest software privilege layer of the VI, a proxy virtual machine (proxy VM) which executes in the guest virtual machine layer of the VI and is protected and trusted by the TCB, and one or more guest virtual machines (VMs) which execute in the guest virtual machine layer of the VI and are protected by the TCB and the proxy VM. The proxy VM is constructed in a computing environment which is independent and separate from the hardware and software systems underlying the VI, and is trusted by the TCB. After construction, the proxy VM is securely transferred to the VI to execute as a special VM in a memory space and a processor context which are protected by the TCB.

In various embodiments, the proxy VM may be configured to perform platform attestation in response to receiving a user request for creating a VM over the VI. Platform attestation may include, for example, reporting the TCB identity and/or the VI configuration to the user. The proxy VM may be configured to run entity authentication protocols with the user. The proxy VM may be configured to establish a two-way secure communication channel between the VI and the user. In one example, the two-way secure communication channel may be used to securely receive user information for constructing and initializing the user VM to run in a memory space and a processor context which are protected by the TCB. The proxy VM may be configured to secure the final exiting state of the VM before a user VM stops, exits the VI and enters into an at rest (rest time) stage saved in an external storage. The proxy VM may be configured to securely resume the VM by obtaining the entering state of the VM and comparing the entering state against its previous exiting state to guarantee consistency between the two states, before an at rest VM resumes back to run in the VI.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

One or more features of the systems and methods may be implemented on one or more computer systems coupled by a network (e.g., the Internet or a cloud computing environment). Example systems upon which various aspects may be implemented, as well as exemplary methods performed by those systems, are discussed in more detail below.

Computer System

Various aspects and functions described herein in accord with the present invention may be implemented as hardware, software, or a combination of hardware and software on one or more computer systems. There are many examples of computer systems currently in use. Some examples include, among others, network appliances, personal computers, workstations, mainframes, networked clients, servers, media servers, application servers, database servers, web servers, and virtual servers. Other examples of computer systems may include mobile computing devices, such as cellular phones and personal digital assistants, and network equipment, such as load balancers, routers and switches. Additionally, aspects in accord with the present invention may be located on a single computer system or may be distributed among a plurality of computer systems connected to one or more communication networks.

For example, various aspects and functions may be distributed among one or more computer systems configured to provide a service to one or more client computers, or to perform an overall task as part of a distributed system. For example, the distributed system may be a cloud computing system. Additionally, aspects may be performed on a client-server or multi-tier system that includes components distributed among one or more server systems that perform various functions. Thus, the invention is not limited to executing on any particular system or group of systems. Further, aspects may be implemented in software, hardware or firmware, or any combination thereof. Thus, aspects in accord with the present invention may be implemented within methods, acts, systems, system placements and components using a variety of hardware and software configurations, and the invention is not limited to any particular distributed architecture, network, or communication protocol. Furthermore, aspects in accord with the present invention may be implemented as specially-programmed hardware and/or software.

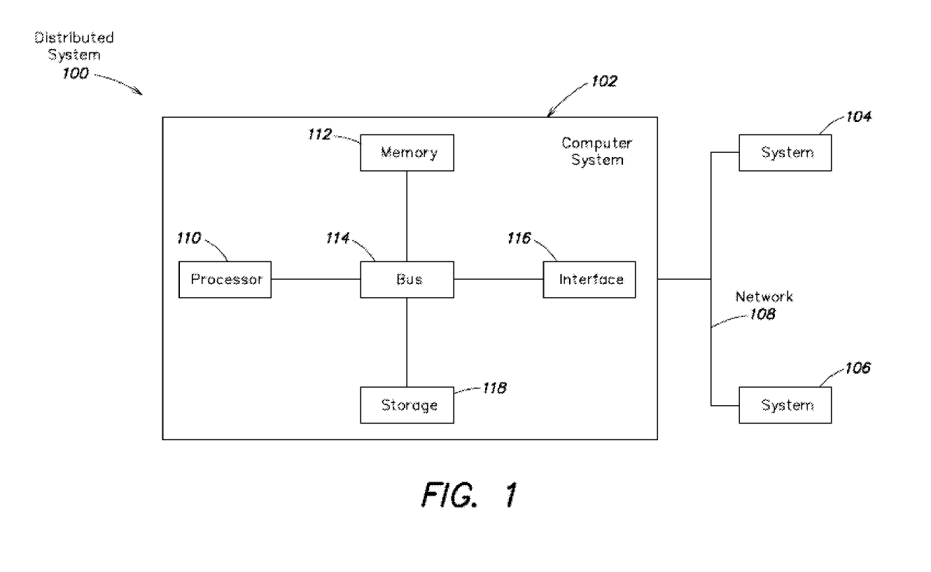

FIG. 1 shows a block diagram of a distributed computer system 100, in which various aspects and functions in accord with the present invention may be practiced. The distributed computer system 100 may include one more computer systems. For example, as illustrated, the distributed computer system 100 includes three computer systems 102, 104 and 106. As shown, the computer systems 102, 104 and 106 are interconnected by, and may exchange data through, a communication network 108. The network 108 may include any communication network through which computer systems may exchange data. To exchange data via the network 108, the computer systems 102, 104 and 106 and the network 108 may use various methods, protocols and standards including, among others, token ring, Ethernet, Wireless Ethernet, Bluetooth, TCP/IP, UDP, HTTP, FTP, SNMP, SMS, MMS, SS7, JSON, XML, REST, SOAP, CORBA IIOP, RMI, DCOM and Web Services. To ensure data transfer is secure, the computer systems 102, 104 and 106 may transmit data via the network 108 using a variety of security measures including TSL, SSL or VPN, among other security techniques. While the distributed computer system 100 illustrates three networked computer systems, the distributed computer system 100 may include any number of computer systems, networked using any medium and communication protocol.

Various aspects and functions in accord with the present invention may be implemented as specialized hardware or software executing in one or more computer systems including the computer system 102 shown in FIG. 1. As depicted, the computer system 102 includes a processor 110, a memory 112, a bus 114, an interface 116 and a storage system 118. The processor 110, which may include one or more microprocessors or other types of controllers, can perform a series of instructions that manipulate data. The processor 110 may be a well-known, commercially available processor such as an Intel Pentium, Intel Atom, ARM Processor, Motorola PowerPC, SGI MIPS, Sun UltraSPARC, or Hewlett-Packard PA-RISC processor, or may be any other type of processor or controller as many other processors and controllers are available. As shown, the processor 110 is connected to other system placements, including a memory 112, by the bus 114.

The memory 112 may be used for storing programs and data during operation of the computer system 102. Thus, the memory 112 may be a relatively high performance, volatile, random access memory such as a dynamic random access memory (DRAM) or static memory (SRAM). However, the memory 112 may include any device for storing data, such as a disk drive or other non-volatile storage device, such as flash memory or phase-change memory (PCM). Various embodiments in accord with the present invention can organize the memory 112 into particularized and, in some cases, unique structures to perform the aspects and functions disclosed herein.

Components of the computer system 102 may be coupled by an interconnection element such as the bus 114. The bus 114 may include one or more physical busses (for example, busses between components that are integrated within a same machine), and may include any communication coupling between system placements including specialized or standard computing bus technologies such as IDE, SCSI, PCI and InfiniBand. Thus, the bus 114 enables communications (for example, data and instructions) to be exchanged between system components of the computer system 102.

Computer system 102 also includes one or more interface devices 116 such as input devices, output devices and combination input/output devices. The interface devices 116 may receive input, provide output, or both. For example, output devices may render information for external presentation. Input devices may accept information from external sources. Examples of interface devices include, among others, keyboards, mouse devices, trackballs, microphones, touch screens, printing devices, display screens, speakers, network interface cards, etc. The interface devices 116 allow the computer system 102 to exchange information and communicate with external entities, such as users and other systems.

Storage system 118 may include a computer-readable and computer-writeable nonvolatile storage medium in which instructions are stored that define a program to be executed by the processor. The storage system 118 also may include information that is recorded, on or in, the medium, and this information may be processed by the program. More specifically, the information may be stored in one or more data structures specifically configured to conserve storage space or increase data exchange performance. The instructions may be persistently stored as encoded signals, and the instructions may cause a processor to perform any of the functions described herein. A medium that can be used with various embodiments may include, for example, optical disk, magnetic disk or flash memory, among others. In operation, the processor 110 or some other controller may cause data to be read from the nonvolatile recording medium into another memory, such as the memory 112, that allows for faster access to the information by the processor 110 than does the storage medium included in the storage system 118. The memory may be located in the storage system 118 or in the memory 112. The processor 110 may manipulate the data within the memory 112, and then copy the data to the medium associated with the storage system 118 after processing is completed. A variety of components may manage data movement between the medium and the memory 112, and the invention is not limited thereto.

Further, the invention is not limited to a particular memory system or storage system. Although the computer system 102 is shown by way of example as one type of computer system upon which various aspects and functions in accord with the present invention may be practiced, aspects of the invention are not limited to being implemented on the computer system, shown in FIG. 1. Various aspects and functions in accord with the present invention may be practiced on one or more computers having different architectures or components than that shown in FIG. 1. For instance, the computer system 102 may include specially-programmed, special-purpose hardware, such as for example, an application-specific integrated circuit (ASIC) tailored to perform a particular operation disclosed herein. Another embodiment may perform the same function using several general-purpose computing devices running MAC OS System X with Motorola PowerPC processors and several specialized computing devices running proprietary hardware and operating systems.

The computer system 102 may include an operating system that manages at least a portion of the hardware placements included in computer system 102. A processor or controller, such as processor 110, may execute an operating system which may be, among others, a Windows-based operating system (for example, Windows NT, Windows 2000/ME, Windows XP, Windows 7, or Windows Vista) available from the Microsoft Corporation, a MAC OS System X operating system available from Apple Computer, one of many Linux-based operating system distributions (for example, the Enterprise Linux operating system available from Red Hat Inc.), a Solaris operating system available from Sun Microsystems, or a UNIX operating systems available from various sources. Many other operating systems may be used, and embodiments are not limited to any particular operating system.

The processor and operating system together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, functions in accord with aspects of the present invention may be implemented using an object-oriented programming language, such as SmallTalk, JAVA, C++, Ada, or C# (C-Sharp). Other object-oriented programming languages may also be used. Alternatively, procedural, scripting, or logical programming languages may be used.

Additionally, various functions in accord with aspects of the present invention may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed placements, or any combination thereof. For example, a web page may be implemented using HTML while a data object called from within the web page may be written in C++. Thus, the invention is not limited to a specific programming language and any suitable programming language could also be used.

A computer system included within an embodiment may perform functions outside the scope of the invention. For instance, aspects of the system may be implemented using an existing product, such as, for example, the Google search engine, the Yahoo search engine available from Yahoo! of Sunnyvale, Calif.; the Bing search engine available from Microsoft of Seattle Wash. Aspects of the system may be implemented on database management systems such as SQL Server available from Microsoft of Seattle, Wash.; Oracle Database from Oracle of Redwood Shores, Calif.; and MySQL from Sun Microsystems of Santa Clara, Calif.; or integration software such as WebSphere middleware from IBM of Armonk, N.Y. However, a computer system running, for example, SQL Server may be able to support both aspects in accord with the present invention and databases for sundry applications not within the scope of the invention.

Exemplary Systems and Methods

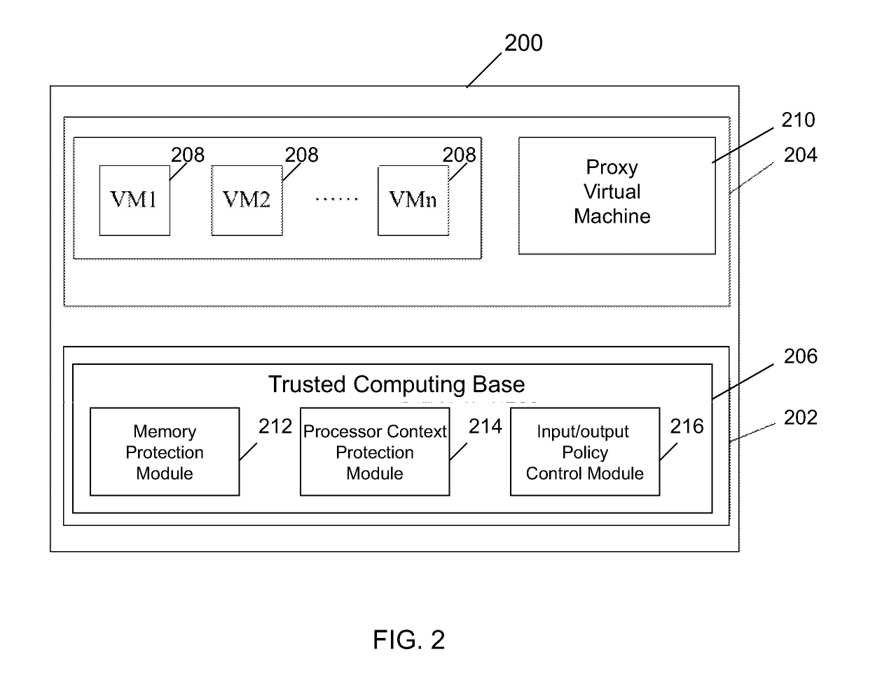

An example system in accordance with aspects of the present invention is shown in FIG. 2. The virtualization infrastructure (VI) 200 is layered or hierarchical, including a first layer 202 and a second layer 204. Each layer has a respective privilege. In this embodiment, the first layer 202 is more privileged than the second layer 204. The first layer 202 is also the most privileged layer of the VI 200. In other embodiments, the VI may include any number of layers.

The VI 200 includes a trusted computing base (TCB) 206 configured to run in the most privileged, first layer 202. The VI 200 includes a plurality of virtual machines (VMs) 208 and a proxy virtual machine (proxy VM) 210 running in the second layer 204. In particular, the plurality of VMs 208 include n VMs (VM1, VM2, . . . , VMn) which are guest VMs. Guest VMs include VMs of users or tenants of a cloud computing system. The second layer 204 may include a guest VM layer. In various embodiments, the VI may include any number of VMs. Each VM 208 is configured to run in the VI 200. Each VM 208 may be configured to exit the VI 200 based on a request from the user of the VM and to enter the VI based on a request from the user of the VM. The proxy VM 210 is also configured to run in the second layer 204 as a proxy of the TCB 206, as will be described in further detail below.

A VM may have exclusive use of its own memory section, processor context, a storage space and one or more input-output (I/O) peripherals. The storage may be an external storage space. A VM may correspond to a respective image file. In some embodiments, a VM as used herein may include an image file of the VM. In some embodiments, systems disclosed herein may be configured to perform one or more acts based on an image file of the VM. In some embodiments, methods disclosed herein may include one or more acts based on an image file of the VM. A VM or an image file of the VM may include one or more blocks of data. In various embodiments, a VM may refer to one or more blocks of data. In some embodiments, a VM may be processed on a block by block basis, as will be described further below. Accordingly, in some embodiments, applying one or more acts disclosed herein to a VM may include applying one or more acts to a block of a plurality of blocks included in the VM.

The VI 200 is configured to provide a trusted and secure environment for full lifecycle protection of the VMs 208. The TCB 206 is configured to prevent unauthorized access to each VM running on the VI 200, including for example the VMs 208 and the proxy VM 210. The TCB 206 may include a hypervisor or a micro kernel. For run time protection of a VM, the VI may be configured to use run time protection technologies similar to those used in existing virtualization infrastructure technologies. For example, the TCB may be the Xen hypervisor which is widely used in the Amazon Cloud. The TCB may include a hardware based TCB. In various embodiments, the TCB may include a software TCB and a hardware TCB, the software TCB being based on the hardware TCB. Hardware root of trust (HROT) based trusted computing technologies, such as the Intel TXT technology or the TCG technology described earlier, may be used to provide integrity protection to the TCB. The HROT based trusted computing may also provide a platform attestation to prove to a user, such as a tenant or other verifiers, that the TCB underlying the VI on the hardware server is properly configured.

Referring to FIG. 2, the TCB 206 includes a memory protection module 212, a processor context protection module 214 and an input-output policy control module 216. The memory protection module 212 may be configured to partition a memory of the VI 200 into a plurality of memory sections that are mutually disjoint. The memory protection module 212 may be configured to maintain a 1:1 access relationship between a VM and a respective memory section corresponding to the VM. Each VM may only access its respective memory section. The memory protection module 212 may be configured to perform housekeeping of access relationships between VMs and their respective memory sections and to prevent unauthorized access to a memory section.

The memory protection module 212 of the TCB 206 may be configured to maintain a TCB memory section that is accessible only by the TCB. The memory protection module 212 may prevent the TCB memory section from being accessed by components other than the TCB, such as a hardware component in the underlying server or a software component. In some embodiments, the VI 200 may include a housekeeping VM configured to run on the VI. The memory protection module 212 may be configured to allow the housekeeping VM to maintain access relationships between VMs and their respective memory sections. The input-output policy control module 216 may be configured to control the access between one or more peripheral devices to one or more memory sections.

The processor context protection module 214 may be configured to maintain a 1:1 access relationship between a VM and a respective processor context corresponding to the VM. Each VM may only access its respective processor context. The processor context protection module 214 may be configured to perform housekeeping of access relationships between VMs and their respective processor contexts and to prevent unauthorized access to a processor context.

In addition to securing a VM 208 during run time, the VI 200 is further configured to secure the VM at construction time and at rest time, as will be described further below. In other embodiments, the VI may be configured to secure the VM only during construction and run time. In yet other embodiments, the VI may be configured to secure the VM only during run time and during rest time.

The VI 200 includes a proxy VM 210 which enables securing a VM 208 during one or more of run time, construction time and rest time. The proxy VM 210 is a dedicated VM configured to run on the VI 200 as a TCB agent or as a proxy of the TCB 206. FIG. 2 shows the proxy VM 210 running in the VI 200.

The proxy VM 210 is trusted by the TCB 206 because it is securely constructed in a trusted computing environment which is independent and separate from the VI 200 and any hardware and software systems underlying the VI, then cryptographically secured and transmitted to the VI. In one embodiment, the VI 200 may operate in a first computing environment and the proxy VM 210 may be constructed in a second computing environment that is different and independent from the first computing environment. For example, the first computing environment may be the system 104 shown in FIG. 1 and the second computing environment may be the system 106 shown in FIG. 1. The independent and separate second computing environment may be cryptographically recognized and trusted by the TCB 206. The TCB 206 may be configured to receive the proxy VM 210 from the separate computing environment.

The proxy VM 210 constructed in the separate computing environment may be cryptographically secured or encoded based on a confidentiality property. The TCB 206 may be configured to use a cryptographic method to verify that the proxy VM 210 is authentic. The TCB 206 may verify that the proxy VM 210 has authentication and confidentiality properties. The proxy VM 210 may be cryptographically secured in such a manner that allows the TCB 206 to verify the correctness and trustworthiness of the proxy VM and to securely retrieve the proxy VM. The TCB 206 may be configured to cryptographically decode the encoded proxy VM.

Without loss of generality, the cryptographic encoding used to secure the proxy VM 210 may include, for example, a digital signature on the proxy VM issued by the separate trusted computing environment where the proxy VM is constructed, such that the TCB 206 may verify the correctness and trustworthiness of the proxy VM using the corresponding public key certificate of the separate trusted computing environment. The cryptographic encoding used to secure the proxy VM 210 may include encryption using the public key of the TCB 206, so as to allow the TCB to decrypt the cryptographically secured proxy VM using the corresponding private key which the TCB has in exclusive possession. In various embodiments, cryptographically encoding the proxy VM may include digitally signing, hashing or encrypting the proxy VM and cryptographically decoding the encoded proxy VM may include verifying a digital signature or hash or decrypting the proxy VM.

The TCB 206 may verify the authenticity of the proxy VM 210 in response to the VI 200 receiving the proxy VM from the separate computing environment where the proxy VM was constructed. In response to authenticating the proxy VM 210, the TCB may allow the proxy VM to run on the VI 200. The proxy VM 210 may run on the VI 200 in a protected space as a special VM. Security protection of the proxy VM 210 may be provided by the TCB 206 during run time.

A proxy VM, as used herein, may include an image file of the proxy VM. In some embodiments, systems disclosed herein may be configured to perform one or more acts based on an image file of the proxy VM. In some embodiments, methods disclosed herein may include one or more acts based on an image file of the proxy VM. The proxy VM 210 or an image file of the proxy VM may include one or more blocks of data. In some embodiments, the proxy VM 210 may be processed block by block. For example, one or more of the acts described above, such as securely constructing, cryptographically securing, transmitting, verifying, encoding and decoding the proxy VM 210 may be performed based on processing one or more blocks of data of the proxy VM at a time. Thus, in some embodiments, the proxy VM 210 may be broken down into a plurality of blocks, and cryptographically protected and verified one block at a time.

In some embodiments, the protection of the proxy VM may be based on the VI running in a first computing environment and based on a separate second computing environment used to construct the proxy VM. Protection of the proxy VM may use the methods and systems disclosed herein for securing a virtual machine. For example, at construction time, the second computing environment where the proxy VM is constructed may be configured to cryptographically encode one or more image file blocks of the proxy VM. Furthermore, the VI running in the first computing environment may be configured to decode the one or more image file blocks of the proxy VM. During run time of the proxy VM on the VI, the VI may cryptographically encode one or more blocks output by the proxy VM and may cryptographically decode one or more blocks input to the proxy VM.

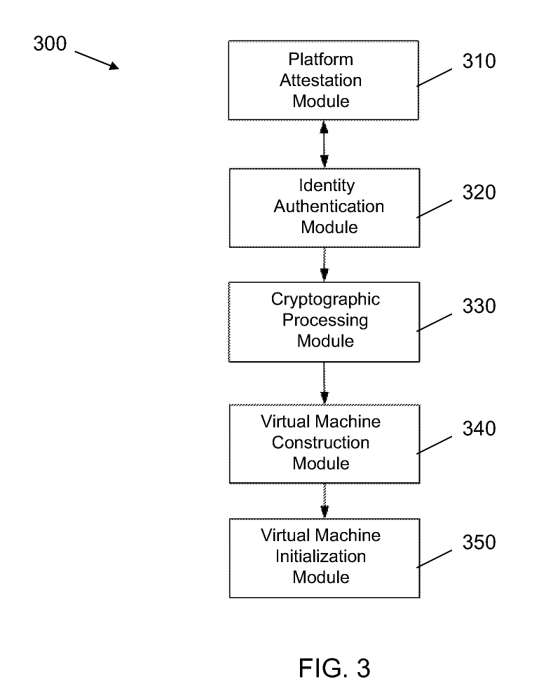

The VI 200 is configured to secure a VM 208 during run time, construction time and rest time using the proxy VM 210 and the TCB 206. Exemplary embodiments of the proxy VM and methods of securing a VM using the proxy VM are described below with reference to FIGS. 3 to 6.

FIG. 3 illustrates a block diagram of an exemplary embodiment of a proxy VM 300. The proxy VM 300 is configured to run on a VI having a TCB as described for example with reference to FIG. 2. In one embodiment, the proxy VM 210 of the VI 200 in FIG. 2 may be the proxy VM 300 of FIG. 3. The proxy VM 300 includes a platform attestation module 310. Upon receipt of a user request for constructing a VM, the platform attestation module 310 may run a platform attestation protocol with the user, reporting to the user the identity and/or configuration of the VI or the TCB. The proxy VM 300 further includes an identity authentication module 320. Upon receipt a user request for constructing a VM, the identity authentication module 320 may run an identity authentication protocol with the user to verify the claimed identity of the user.

The proxy VM 300 further includes a cryptographic processing module 330. The cryptographic processing module 330 may be configured to establish a two-way cryptographically protected secure communication channel between the proxy VM 300 and the user in response to successfully running attestation and authentication protocols with the user, thereby securing communications with the user.

The proxy VM 300 further includes a VM construction module 340 and a VM initialization module 350. The VM construction module 340 may be configured to securely construct a VM for the user using data, such as VM construction information, received from the user via the established two-way secure communications channel. The VM initialization module 350 may be configured to initialize the VM for the user, thereby making the VM exclusively usable by the user, based on data received from the user via the established two-way secure communications channel.

FIG. 3 shows an exemplary communication pattern between the modules as indicated by arrows. In one example, the platform attestation module 310 and the identity authentication module 320 may be configured to communicate so as to provide attestation and verify an identity of the user. The cryptographic processing module 330 may then receive a confirmation that an identity of the user has been verified. The cryptographic processing module 330 may then establish secure communication with the user and receive information such as VM construction and initialization information from the user. The VM construction and initialization information may be communicated to the VM construction module 340 and the VM initialization module 350.

The arrangement of the various modules in FIG. 3 is exemplary and other configurations and communication flows among the modules may be realized in various embodiments. In some embodiments, the proxy VM may be configured to perform the various acts disclosed herein using any number of modules. In some embodiments, the proxy VM may include one or more modules and the modules may be configured to perform various other acts. The modules may also be configured to perform various acts in different orders and the acts performed by any of the modules may overlap. In some embodiments, various acts may be performed substantially in parallel. For example, in one embodiment, platform attestation and identity authentication may overlap at least partially.

The proxy VM 300 may further be configured to compute an initial state measurement of the VM at the time when the VM is constructed. For example, the initial state measurement may be computed following construction of the VM and prior to initially running of the VM on the VI. The proxy VM 300 may further be configured to use the initial state measurement to prevent an unauthorized initial running of the newly constructed VM on the VI. In one embodiment, the VM initialization module 350 may be configured to compute the initial state measurement. In other embodiments, another module may be used to compute the initial state measurement.

As described above, the VM may include one or more blocks of data and may be processed block by block. For example, the proxy VM 300 may be configured to compute an initial state measurement for each block of the one or more blocks. In some embodiments, the initial state measurement may include or may be based on a respective initial state measurement for each block of the one or more blocks of the VM.

The proxy VM 300 may further be configured to cryptographically secure the initial state measurement. The proxy VM 300 may be configured to generate an image file for the VM and may further be configured to securely store the image file. In one example, the image file may be securely stored on a storage space external to the VI. Various embodiments of systems and methods of securing a VM, whether at run time, initial launch time or at rest (stoppage) time, may be based on the image file of the VM.

The proxy VM 300 may further include other modules not illustrated in FIG. 3. For example, the proxy VM 300 may include a VM resuming module. In one embodiment, the newly constructed VM may be at rest and therefore not running on the VI. The VM resuming module may be configured to compute a resuming state measurement for the VM upon receiving a request from the user to resume the VM, to run the VM on the VI. The VM requested to be resumed may be a newly constructed VM that is at rest or may be a VM that previously exited the VI. In one example, the user may request initially running a new VM and the resuming state measurement may be computed at the time when a request to initially run the VM on the VI is received. The VM resuming module may be configured to compare the resuming state measurement with the initial state measurement previously computed for the newly constructed VM. The proxy VM may prevent unauthorized initial running of the VM on the VI based on a negative outcome of the comparison. For example, a negative outcome may include an inconsistency of the resuming state measurement with the initial state measurement. The proxy VM may also allow the VM to run on the VI based on a positive outcome of the comparison. For example, a positive outcome of the comparison may include a consistency of the resuming state measurement with the initial state measurement. Once the VM runs on the VI, the TCB running on the VI may provide security protection to the VM.

As discussed above for the initial state measurement, in some embodiments the resuming state measurement may also be computed for each block of one or more blocks of the VM. In some embodiments, comparing the resuming state measurement with the initial state measurement may also be done individually for each block of the one or more blocks.

In some embodiments, the proxy VM 300 may further include a VM securing module. The VM securing module may be configured to compute an exit state measurement for the VM in response to receiving a request from the user for the VM to exit the VI or to stop the VM. The exit state measurement may be computed at a time when the VM exits the VI. As discussed above for the initial state measurement and the resuming state measurement, in some embodiments the exit state measurement may also be computed for each block of one or more blocks of the VM. In some embodiments, the exit state measurement may be computed for one or more blocks of data output from the VM during run time of the VM. In some embodiments, stoppage or exit of the VM from the VI may not cause output or writing of one or more blocks of data to the image file of the VM, unless there is at least one block of data in the memory which has not been output. In some embodiments, an exit state measurement may be computed if and only if a VM outputs at least one block of data. The VM securing module may further be configured to use a cryptographic method to secure the exit state measurement.

The proxy VM 300 may be configured to use the exit state measurement to prevent an unauthorized entry of the VM into the VI. An unauthorized entry may include, for example, an attempt to run the VM by a user who is not authorized to access the VM. In some embodiments, the proxy VM 300 may be configured to use the exit state measurement to prevent an unauthorized input of one or more blocks of data into the VM during run time. In some embodiments, the VM resuming module may be configured to retrieve an exit state measurement of a VM in response to receiving a request to resume or enter the VM into the VI. The VM resuming module may further be configured to compute a resuming state measurement for the VM and to compare the resuming state measurement with the retrieved exit state measurement. The proxy VM may prevent unauthorized entry of the VM into the VI based on a negative outcome of the comparison. For example, a negative outcome may include an inconsistency of the resuming state measurement with the exit state measurement. The proxy VM may also allow the VM to run on the VI based on a positive outcome of the comparison. For example, a positive outcome of the comparison may include a consistency of the resuming state measurement with the exit state measurement. In some embodiments, comparing the resuming state measurement with the exit state measurement may also be done individually for each block of the one or more blocks of the VM. Once the VM runs on the VI, the TCB running on the VI may provide security protection to the VM. For example, referring to FIG. 2, the TCB 206 provides security protection to each VM 208 running on the VI 200.

Furthermore, the proxy VM may be configured to secure one or more blocks of data output from a VM during run time of the VM, based on various measurements disclosed herein. The proxy VM may be configured to cryptographically secure one or more blocks of data output from the VM, for example based on computing an exit state measurement corresponding to the one or more blocks of data output from the VM during run time of the VM. For example, one or more blocks of data may be output to an image file of the VM. The proxy VM may be configured to cryptographically verify one or more blocks of data input to the VM, for example based on computing a resuming state measurement of the one or more blocks of data input to the VM and comparison of the resuming state measurement with the exit state measurement of the one or more blocks of data. The one or more blocks of data may be input from or read from an image file of the VM. The proxy VM may be configured to cryptographically secure an output from a VM and to cryptographically verify an input to a VM during one or more of the run time, rest time and construction time of the VM.

In various embodiments, one or more of an initial state measurement, a resuming state measurement and an exit state measurement may be computed based on at least one block of one or more blocks of the VM. In various embodiments, one or more of an initial state measurement, a resuming state measurement and an exit state measurement may be computed using an image file of the VM. One or more of an initial state measurement, a resuming state measurement and an exit state measurement may be a cryptographic measurement.

As used herein, entry, resuming or input into the VI may include data flow from an external storage space into a memory space of the VI. Entry of a VM into the VI may include entry of one or more data blocks of the VM into the VI. In some embodiments, entry may include entry of at least one data block of a plurality of data blocks of the VM into the VI. When a VM enters the VI, one or more blocks of the VM may enter the VI. As used herein, exit or output from the VI may include data flow from a memory space of the VI to an external storage space. In some embodiments, the external storage space may be insecure, while the memory space of the VI is secure according to aspects of the present disclose. Exit of a VM from the VI may include exit of one or more data blocks of the VM from the VI. In some embodiments, exiting may include exiting of at least one data block of a plurality of data blocks of the VM from the VI. When a VM exits the VI, one or more blocks of the VM may exit the VI.

As used herein, running a VM or a proxy VM may include running one or more blocks of the VM or the proxy VM. In some embodiments, one or more blocks of a plurality of blocks of a VM or a proxy VM may be running on the VI. In some embodiments, when a VM exits the VI, thereby outputting one or more blocks, the VI may compute a cryptographic protection for one or more output blocks of the VM. When a VM enters the VI, thereby inputting one or more blocks into the VI, the VI may verify the correctness of the crypto protection for one or more input blocks. In some embodiments, correctness may be verified for one or more blocks based on the cryptographic protection previously computed with respect to the one or more blocks. As described above, exit state measurements and resuming state measurements may be computed and compared for one or more blocks and used to prevent unauthorized access to the VM.

Various embodiments of the VI disclosed herein may be configured to run on a cloud computing data center. In various embodiments, the TCB may be configured to prevent unauthorized access to a VM by an administrator of the cloud computing data center. The proxy VM may be configured to prevent unauthorized entry of a VM into the VI by an administrator of the cloud computing data center.

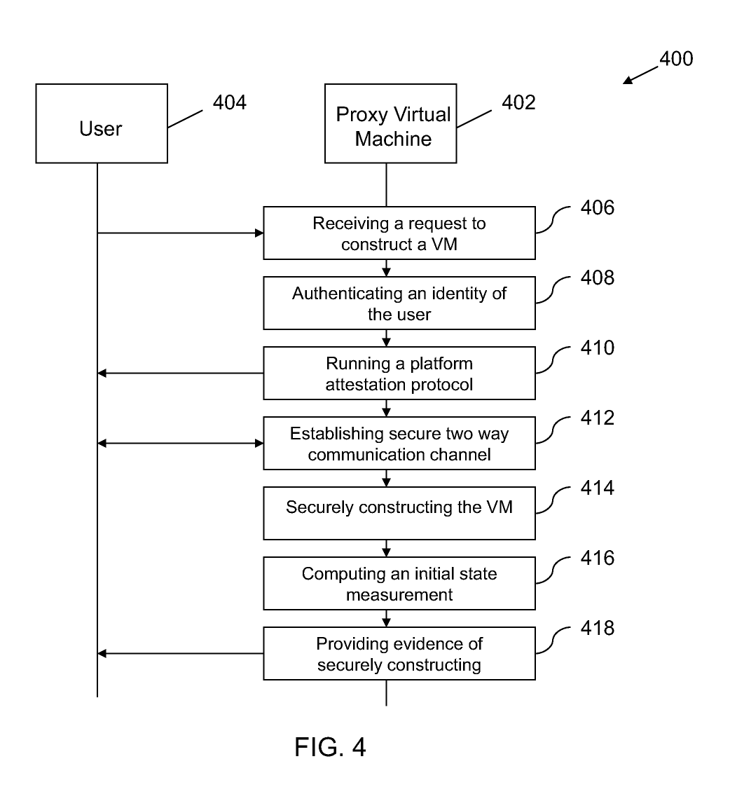

Exemplary methods of securing a VM during construction time, run time and rest time, by using a VI including a TCB and a proxy VM, are described below and with reference to FIGS. 4 to 6. In various embodiments, securing a VM during construction time may include one or more acts of receiving from a user, such as a cloud tenant, a request for ordering a new VM, running a secure handshaking protocol with the user, authenticating the claimed identity of the user, cryptographically securing the authenticated user's identity and credential information using cryptographic support from the TCB and in turn from the HROT. Securing the VM during construction time may further include running a remote attestation protocol with the authenticated user, reporting the TCB identity and the VI configuration to the user using the trusted computing support from the TCB and in turn from the HROT. After successfully running authentication and attestation protocols with the user who requested a new VM, customizing and constructing a new VM for the user, and initializing the logging-in credential of the VM. Securing the VM during construction time may further include one or more acts of computing a cryptographic measurement for the new VM, cryptographically securing the measurement result, cryptographically securing VM data, and allowing the newly constructed VM to rest. In some embodiments, the newly constructed VM may be allowed to enter the VI following construction. Once a VM enters the VI, the VM may be secured at run time using the TCB running on the VI.

In various embodiments, a method of securing the VM during run time and/or rest time may include one or more acts of computing a cryptographic measurement for the final state of the VM when a user stops a VM, cryptographically securing the measurement result, cryptographically securing VM data, and allowing the VM to rest upon exiting the VI. When a user launches a VM that is at rest, securing the VM may include one or more acts of computing a current cryptographic measurement for the VM image file, comparing the current cryptographic measurement with a previous measurement corresponding to the VM, and letting the VM enter run time only if the comparison is successful. The comparison may be successful, for example, if the current measurement is consistent with the previous measurement. Once a VM enters the VI, the VM may be secured at run time using the TCB running on the VI.

FIG. 4 illustrates an exemplary method 400 for securing a VM at construction time using a proxy VM. The proxy VM 402 is configured to perform method 400 as shown in FIG. 4, in response to a request from the user 404 to construct a VM. According to aspects of the present disclosure, the proxy VM 402 may be running in a VI having a TCB as shown for example in FIG. 2. The arrows shown in FIG. 4 indicate communications with the user 404. The method 400 of securing the VM includes an act 406 of receiving a request from the user 404 to construct a VM. The method 400 includes an act 408 of authenticating an identity of the user 404 in response to receiving the request to construct a new VM. In one example, act 408 may be performed using the identity authentication module 320 shown in FIG. 3. The method 400 further includes running a platform attestation protocol in act 410. Act 410 may include, for example, reporting to the user 404 the identity of the VI in which the proxy VM 402 is running. In one example, act 410 may be performed using the platform attestation module 310 shown in FIG. 3. Method 400 further includes an act 412 of establishing secure two-way communication with the user 404 after successfully completing acts 408 and 410 of authenticating and running the platform attestation protocol with the user. In one example, act 412 may be performed using the cryptographic processing module 330 shown in FIG. 3. Once secure communication is established, the user 404 may send data for use in constructing and/or initializing the new VM. Method 400 includes an act 414 of securely constructing the VM, for example by using data received from the user via the secure communication channel. Act 414 may further include initializing the VM. In one example, act 414 may be performed using the VM construction module 340 shown in FIG. 3. Method 400 includes computing an initial state measurement for the VM in act 416. The initial state measurement may be a cryptographic measurement computed by the proxy VM as described in various embodiments. In some embodiments, computing an initial state measurement may include computing one or more initial state measurements for one or more blocks of the VM. In some embodiments, method 400 may further include cryptographically securing the computed initial state measurement. Method 400 further includes an act 418 of providing evidence of securely constructing the VM to the user 404.

In various embodiments, the method 400 may include other acts. Some acts included in method 400 may be performed in another order, may overlap or may be performed substantially in parallel. For example, in one embodiment, acts 414 and 416 may overlap. In some embodiments, various acts of method 400 may further rely on the TCB included in the VI. For example, act 408 of authenticating an identity of the user may further include cryptographically securing the authenticated user's identity and credential information using cryptographic support from the TCB.

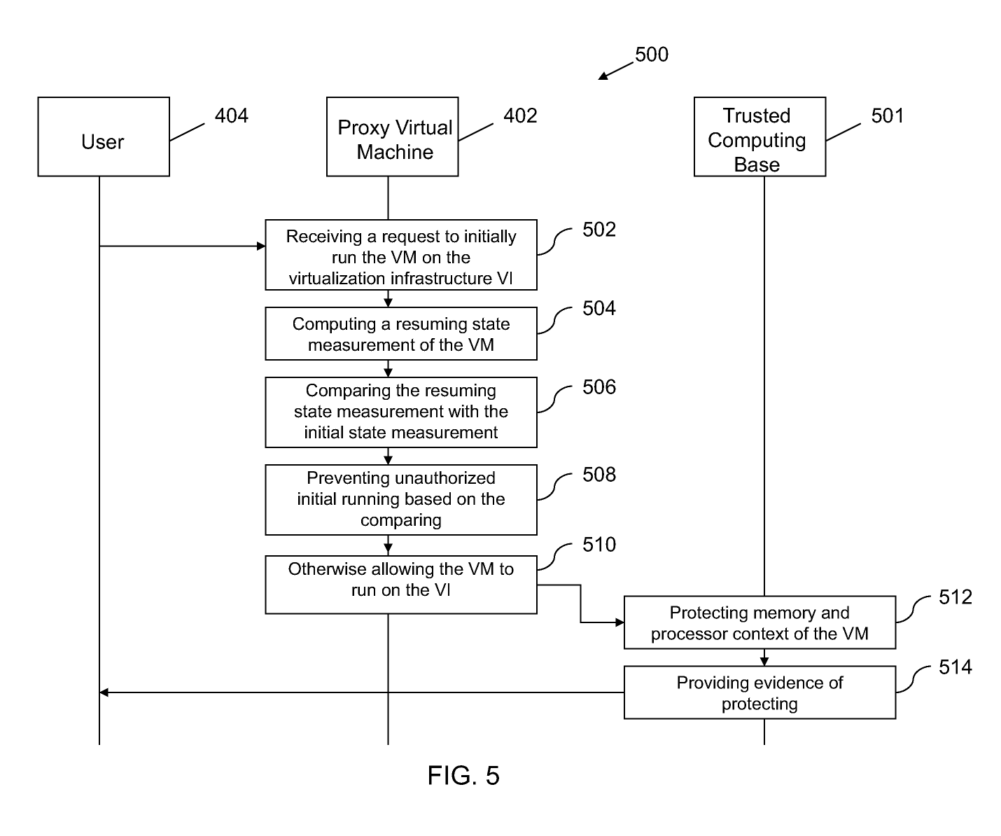

FIG. 5 illustrates an exemplary method 500 of securing a VM following construction time and during initial running of the newly constructed VM on the VI. The VM may be the same VM constructed using method 400 of FIG. 4. Method 500 includes acts performed by the proxy VM 402 and the TCB 501, wherein both the proxy VM and the TCB are running on a VI according to aspects disclosed herein. The VM constructed according to method 400 may be at rest. The user 404 may send a request to initially run the new VM on the VI. Method 500 includes an act 502 of receiving a request from the user 404 to initially run the VM. In response to receiving the request, the proxy VM 402 computes a resuming state measurement of the VM in act 504. The resuming state measurement may be a cryptographic measurement computed by the proxy VM as described in various embodiments. In some embodiments, computing the resuming state measurement may include computing one or more resuming state measurements for one or more blocks of the VM. Method 500 further includes an act 506 of comparing the resuming state measurement with the initial state measurement computed in act 416 of FIG. 4. Act 506 may include comparing the measurements for each block of data of the VM. Method 500 includes an act 508 of preventing unauthorized initial running of the VM based on the result of the comparing act 506. For example, the result of comparing may include an inconsistency between the initial state measurement and the resuming state measurement, thereby indicating an attempt to run the VM by an unauthorized user. If the comparison indicates consistency between the initial state measurement and the resuming state measurement, the proxy VM may perform act 510 of allowing the VM to run on the VI.

Once the VM runs on the VI, the VM may be protected by the TCB 501 at run time. Method 500 may further include an act 512 of protecting a memory section and processor context of the VM using the TCB 501. Act 512 may further include controlling access between a peripheral device and a memory section by using the TCB. The TCB 501 may be configured, for example, as described in relation to the TCB 206 in FIG. 2. Act 512 may further include additional acts performed by using the memory protection module 212, the processor context protection module 214 and the I/O policy control module 216 as shown and described in relation with FIG. 2. Method 500 may further include an act 514 of providing evidence of protecting the VM by the TCB to an authorized user.

In various embodiments, the method 500 may include other acts. Some acts included in method 500 may be performed in another order, may overlap or may be performed substantially in parallel. In some embodiments, various acts of method 500 shown to be performed by the proxy VM 402 may further rely on the TCB 501.

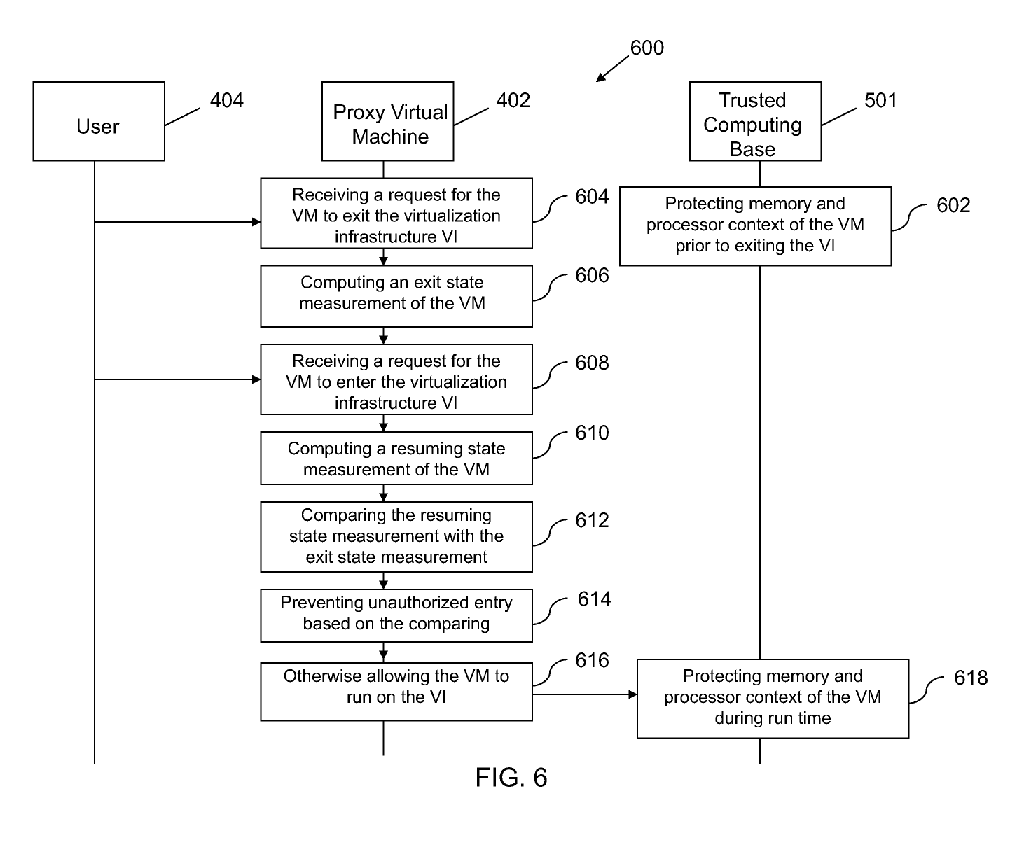

FIG. 6 illustrates an exemplary method 600 of securing a VM during run time and during rest time. Rest time may be between when the VM exits the VI and when the VM enters the VI. For example, the VM may be the same VM that was constructed and initially run on the VI having the proxy VM 402 and TCB 501 as described in FIGS. 4 and 5. As shown in FIG. 6, method 600 includes an act 602 of protecting a memory section and processor context of the VM while the VM is running on the VI. The user 404 may send a request to stop the VM. Method 600 includes an act 604 of receiving a request from the user 404 for the VM to exit the VI. Method 600 further includes an act 606 of computing an exit state measurement of the VM, in response to receiving the request from the user 404. The exit state measurement may be a cryptographic measurement computed by the proxy VM as described in various embodiments. In some embodiments, computing the exit state measurement in act 606 may include computing one or more exit state measurements for one or more blocks of the VM.

As the VM exits the VI, the VM may be at rest. The VM may stay at rest until a user requests resuming the VM. Method 600 further includes an act 608 of receiving a request from the user 404 to enter the VI. Acts 608 to 618 of method 600 may be similar to acts 502 to 512 of method 500, but based on the exit state measurement instead of the initial state measurement.

In response to receiving the request in act 608, the proxy VM 402 computes a resuming state measurement of the VM in act 610. The resuming state measurement may be a cryptographic measurement computed by the proxy VM as described in various embodiments. In some embodiments, computing the resuming state measurement may include computing one or more resuming state measurements for one or more blocks of the VM. Method 600 further includes an act 612 of comparing the resuming state measurement with the exit state measurement previously computed in act 606. Act 612 may include comparing the measurements for each block of data of the VM. Method 600 includes an act 614 of preventing unauthorized running of the VM based on the result of the comparing act 612. For example, the result of comparing may include an inconsistency between the exit state measurement and the resuming state measurement, thereby indicating an attempt to run the VM by an unauthorized user or an attempt to run a modified VM. If the comparison indicates consistency between the exit state measurement and the resuming state measurement, the proxy VM may perform act 616 of allowing the VM to run on the VI. Once the VM runs on the VI, the VM may again be protected by the TCB 501 at run time, as shown by act 618 of protecting a memory section and processor context of the VM.

In various embodiments, the method 600 may include other acts. Some acts included in method 600 may be performed in another order, may overlap or may be performed substantially in parallel. In some embodiments, various acts of method 600 shown to be performed by the proxy VM 402 may further rely on the TCB 501. In some embodiments, various acts of method 600 shown to be performed by the TCB 501 may further rely on the proxy VM 402.

In some embodiments, method 600 may include one or more acts directed to securing an output or input of a VM during run time of the VM, using the proxy VM 402. For example, method 600 may include an act of cryptographically securing one or more blocks of data output from the VM, based on computing an exit state measurement corresponding to the one or more blocks of data output from the VM during run time of the VM. Method 600 may include cryptographically verifying one or more blocks of data input to the VM, for example based on computing a resuming state measurement of the one or more blocks of data input to the VM and comparing the resuming state measurement with the exit state measurement of the one or more blocks of data during run time of the VM.

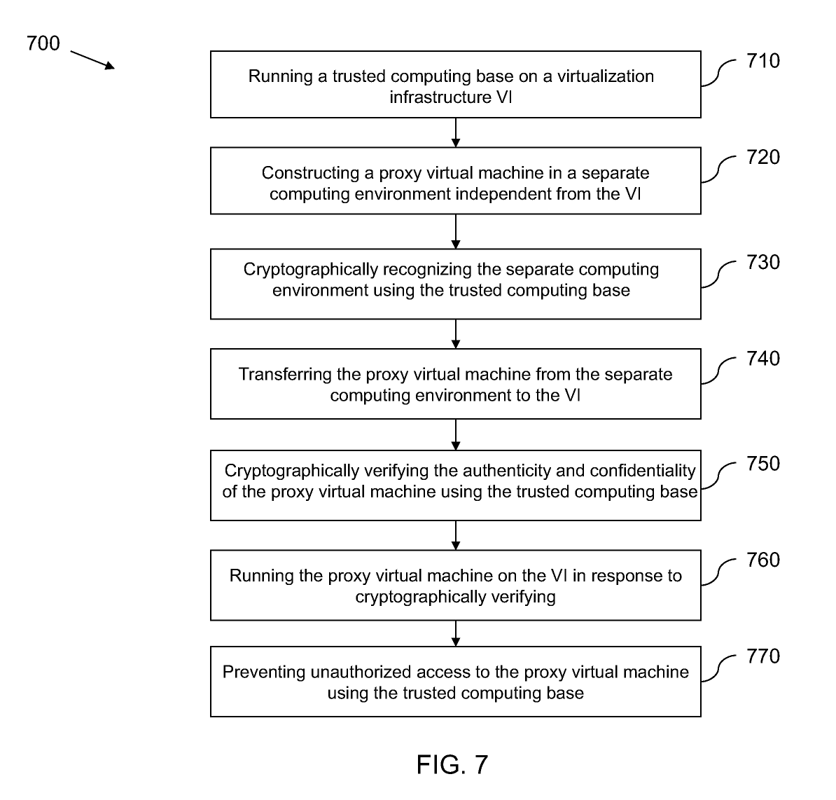

FIG. 7 illustrates an exemplary method 700 of securing a proxy VM according to aspects disclosed herein. Method 700 includes running a TCB on a VI in act 710, as shown for example in FIG. 2. Method 700 includes constructing a proxy VM in a separate computing environment that is independent from the VI. For example, referring to FIG. 1, the VI may be operating in system 104 and the separate computing environment may be system 106. Method 700 further includes cryptographically recognizing the separate computing environment using the TCB in act 730 and transferring the proxy VM from the separate computing environment to the VI in act 740, in response to recognizing and trusting the separate computing environment.

Method 700 further includes cryptographically verifying the authenticity and confidentiality of the proxy VM using the TCB in act 750 and running the proxy VM on the VI in act 760, in response to cryptographically verifying that the proxy VM is authentic. In some embodiments, act 760 may include running the proxy VM in a layer of the VI that is less privileged than the TCB layer. Once the proxy VM runs on the VI, as shown for example by the proxy VM 210 in FIG. 2, the TCB provides security protection to the proxy VM. In act 770 of method 700, the TCB prevents unauthorized access to the proxy VM.

In various embodiments, the method 700 may include other acts. For example, method 700 may include cryptographically encoding the proxy VM on the separate computing environment using a cryptographic method to generate an encoded proxy VM, receiving the encoded proxy VM by the TCB and cryptographically decoding the proxy VM using the cryptographic method on the TCB. Some acts included in method 700 may be performed in another order, may overlap or may be performed substantially in parallel.

According to another embodiment, a VI may not include a proxy VM and the VI may be configured to perform various acts disclosed in relation to the proxy VM. For example, the VI may be configured to compute one or more cryptographic measurements used to secure a VM during construction time, run time and rest time. In one embodiment, the VI 200 illustrated in FIG. 2 may not include the proxy VM 210. According to another embodiment, a method of securing a VM may include acts performed by the VI in lieu of a proxy VM. For example, in some embodiments, various acts shown to be performed by the proxy VM 402 in FIGS. 4-6 may instead be performed by the VI.

In other embodiments, aspects disclosed herein may apply to an operating system. For example, systems and methods may be provided for securing an operating system, similar to securing a virtual machine. An operating system may be secured during one or more of construction time, run time and stoppage time. An exit state measurement of one or more blocks of data may be cryptographically computed in response to outputting one or more blocks of data by an operating system to a storage area of the operating system. A resuming state measurement of the one or more blocks of data may be computed in response to receiving the one or more blocks from the storage area and the resuming state measurement may be compared to the exit state measurement. Systems for securing an operating system may further be configured to include one or more features disclosed above in relation with various embodiments of the virtualization infrastructure. In some embodiments, a virtual machine may include an operating system and securing the virtual machine may include securing the operating system.

Various embodiments of the apparatuses and methods disclosed herein may be used to enhance virtualization and security technologies, such as Intel TXT and other technologies based on hardware root of trust. Various embodiments may be adopted in the server side or in cloud data centers, to provide full lifecycle protection for virtual machines. Embodiments may be used in the server side for a variety of applications, including for example electronic commerce and social networking applications.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

What is claimed is:

1. A virtualization infrastructure for securing a virtual machine, the virtualization infrastructure including:
a trusted computing base configured to prevent unauthorized access to the virtual machine running on the virtualization infrastructure;
a proxy virtual machine running on the virtualization infrastructure as a proxy of the trusted computing base, the trusted computing base further being configured to use a cryptographic method to verify the proxy virtual machine to have authentication and confidentiality properties to prevent unauthorized access to the proxy virtual machine;
the proxy virtual machine having authentication and confidentiality properties and being configured to compute an exit state measurement of an image file of the virtual machine at a time when the virtual machine outputs data to the image file of the virtual machine and to use the exit state measurement to prevent an unauthorized running of the virtual machine on the virtualization infrastructure.

2. The virtualization infrastructure of claim 1, wherein the image file of the virtual machine includes one or more blocks of data and the proxy virtual machine is configured to compute the exit state measurement using at least one block of the one or more blocks.

3. The virtualization infrastructure of claim 1, wherein the image file of the virtual machine includes one or more blocks of data and the proxy virtual machine is configured to compute the exit state measurement for each block of the one or more blocks.

4. The virtualization infrastructure of claim 1, wherein the proxy virtual machine is further configured to cryptographically secure the exit state measurement.

5. The virtualization infrastructure of claim 1, wherein the proxy virtual machine is further configured:
to compute a resuming state measurement of the image file of the virtual machine at a time when the virtual machine inputs data from the image file of the virtual machine;
to compare the resuming state measurement with the exit state measurement;
to prevent an unauthorized running of the virtual machine on the virtualization infrastructure based on a negative outcome of the comparison; and
to allow the virtual machine to run on the virtualization infrastructure based on a positive outcome of the comparison.

6. The virtualization infrastructure of claim 5, wherein the image file of the virtual machine includes one or more blocks of data and the proxy virtual machine is configured to compute the resuming state measurement for each block of the one or more blocks and to compare the resuming state measurement with the exit state measurement for each block of the one or more blocks.

7. The virtualization infrastructure of claim 1, wherein the proxy virtual machine is further configured to securely construct the virtual machine, to compute an initial state measurement of the image file of the virtual machine at a time when the virtual machine is constructed, and to use the initial state measurement to prevent an unauthorized initial running of the virtual machine on the virtualization infrastructure.

8. The virtualization infrastructure of claim 7, wherein the image file of the virtual machine includes one or more blocks of data and the proxy virtual machine is configured to compute the initial state measurement for each block of the one or more blocks.

9. The virtualization infrastructure of claim 7, wherein the proxy virtual machine is further configured to receive from a user a request to construct the virtual machine.

10. The virtualization infrastructure of claim 9, wherein the proxy virtual machine is further configured to run upon receipt of the request to construct the virtual machine:
an authentication protocol to verify an identity of the user; and
an attestation protocol to report an identity of the virtualization infrastructure to the user; and
to establish a secure two-way communication channel with the user in response to a successful authentication and attestation.

11. The virtualization infrastructure of claim 10, wherein the proxy virtual machine is further configured to report a configuration of the virtualization infrastructure to the user.

12. The virtualization infrastructure of claim 10, wherein the proxy virtual machine is further configured to receive data from the user via the secure two-way communication channel, and to use the data to construct and initialize the virtual machine.

13. The virtualization infrastructure of claim 7, wherein the proxy virtual machine is further configured to cryptographically secure the initial state measurement.

14. The virtualization infrastructure of claim 1, being configured to run on a cloud computing data center.

15. The virtualization infrastructure of claim 14, wherein:
the trusted computing base is further configured to prevent unauthorized access to the virtual machine by an administrator of the cloud computing data center; and
the proxy virtual machine is further configured to prevent unauthorized running of the virtual machine on the virtualization infrastructure by the administrator of the cloud computing data center.

16. The virtualization infrastructure of claim 1, wherein the trusted computing base is configured to run in a first layer of the virtualization infrastructure, the virtual machine is configured to run in a second layer of the virtualization infrastructure, the first layer being more privileged than the second layer.

17. The virtualization infrastructure of claim 16, wherein the proxy virtual machine is configured to run in the second layer of virtualization infrastructure.

18. The virtualization infrastructure of claim 1, wherein the trusted computing base includes a hypervisor or a micro kernel.

19. The virtualization infrastructure of claim 1, wherein the trusted computing base includes a memory protection module configured to:
partition a memory of the virtualization infrastructure into a plurality of memory sections, the plurality of memory sections being mutually disjoint;
maintain a 1:1 access relationship between a memory section of the plurality of memory sections and the virtual machine;
maintain a trusted computing base memory section accessible only by the trusted computing base.

20. The virtualization infrastructure of claim 19, further including a housekeeping virtual machine running on the virtualization infrastructure, the memory protection module being further configured to allow the housekeeping virtual machine to maintain the 1:1 access relationship between a memory section of the plurality of memory sections and the virtual machine.

21. The virtualization infrastructure of claim 19, wherein the trusted computing base further includes an input-output policy control module configured to control access between a peripheral device and a memory section.

22. The virtualization infrastructure of claim 1, the virtual machine having a processor context, wherein the trusted computing base further includes a processor context protection module configured to maintain a 1:1 access relationship between the processor context and the virtual machine.

23. The virtualization infrastructure of claim 1, wherein the virtualization infrastructure is configured to operate in a first computing environment and the proxy virtual machine is constructed in a second computing environment, the second computing environment being separate and independent from the first computing environment.

24. The virtualization infrastructure of claim 23, wherein the trusted computing base is further configured to cryptographically recognize and trust the second computing environment and to receive an image file of the proxy virtual machine from the second computing environment.

25. The virtualization infrastructure of claim 24, wherein the image file of the proxy virtual machine is cryptographically encoded on the second computing environment using the cryptographic method, and wherein the trusted computing base is further configured to receive the cryptographically encoded image file of the proxy virtual machine from the second computing environment and to cryptographically decode the image file of the proxy virtual machine using the cryptographic method.
